(19) United States
(12) Patent Application Publication
(10) Pub. No.: US 2008/0041511 A1
(43) Pub. Date: Feb. 21, 2008

(54) VEHICLE TIRES

(76) Inventor: Charles Watkinson, Yorkshire (GB)

Correspondence Address: EDWIN D. SCHINDLER, FIVE HIRSCH AVENUE, P.O. BOX 966, CORAM, NY, 11727-0966, US

(21) Appl. No.: 11/839,050

(22) Filed: Aug. 15, 2007

(30) Foreign Application Priority Data
Aug. 16, 2006 (GB) 0616287.9

(51) Int. Cl. B60C 11/14

(52) U.S. Cl. 152/210; 152/208

(57) ABSTRACT

A vehicle tire contains a filler which includes glass flake. A preferred thickness of the glass flake is up to 1000 nm. The preferred particle size is greater than 80 nm. The filler may be included in the tire tread, the sidewall of the tire or both.

### BACKGROUND OF THE INVENTION

1. Technical Field of the Invention

The present invention relates, generally, to vehicle tires and, in particular, to tires having reinforcing fillers

2. Description of the Prior Art

So-called precipitated silica has been proposed for use as a reinforcing filler in vehicle tires. Certain mechanical properties of the tires are enhanced including rolling resistance, adherence to wet or snow-covered ground and wear resistance.

The silica is in the form of beads having a mean diameter of up to 500 nm. Below that value, any variation in the mean diameter has no impact on the reinforcing properties.

### SUMMARY OF THE INVENTION

According to the present invention, there is provided a vehicle tire having a tread and/or a sidewall containing a filler including glass flake.

The aspect ratio dimensions that can be produced in manufacturing glass flakes are, unlike precipitated silica, substantially variable and therefore glass flakes can be produced within a specific range of dimensions appropriate to the improvement of tire performance. This glass flake can expect to give rise to much better properties, such as those mentioned above, in car tires including improved wear and reduced rolling resistance. In addition, the use of glass flakes substantially reduces gas diffusion through the rubber, particularly at the sidewall, allowing for a longer time before re-inflation. Further, the glass flake aids thermal conductivity by reducing overall the temperature in operation. Reducing the heat build-up in the side wall of the tire results in improved run-flat properties.

The improved properties resulting from the use of glass flake in car tire treads may also be due to the better packing properties of glass flake as compared with precipitated silica. The latter has a shape rather like flattened globules of glass. The flatness of the particle is important, giving rise to good contact between the tire and the road, rather than that obtained by a particle having a more rounded profile. Rolling resistance is reduced because of the reduced amount of rubber in contact with the road.

Preferably, the thickness of the glass flake is up to 1000 nm. More preferably, the thickness of the glass flake is below 400 nm. A particularly preferred glass flake for this application, having a particle size in the planar direction of D50 up to 170 μm and a thickness of around 350 nm, is found to give particularly good properties to car tire treads. Glass flake particles of lower thickness and planar dimension are consistent with sidewall use.

Preferably, the average particle size thickness of the glass flake ranges from 80 nm to 1000 nm and a planar dimension of D50 from 5 μm to 250 μm. More preferably, the average particle size thickness is from 100 nm to 400 nm and the D50 is from 20 μm to 50 μm.

### DETAILED DESCRIPTION OF THE PREFERRED EMBODIMENTS

Glass flakes in accordance with the present invention may be made by a process similar to that described in European Patent Application No. EP 0 289 240. This method uses a spinning cup to produce a flat film of molten glass, which is flung as a film in a radially outwards direction from the rim of the cup. The film is spread between two plates which form an annular venturi and is super-cooled with forced air. The film is broken up as a result of the high velocity air stream and the drag (i.e., frictional resistance) imparted by it.

The parameters involved in producing a flat glass flake of even thickness are varied and complex. They include:
glass composition, melt temperature and viscosity;
temperature of glass in the melt tank;
mass flow of glass leaving the tank and entering the cup;
temperature of the glass entering the cup;
distance between the outlet of the glass tank and entry to the cup;
diameter and depth of the cup;
heat dissipation properties of the cup;
rotational speed of the cup;
distance between the rim of the cup and entry to the radial venture;
distance of the plates forming the radial venture;
diameter of the venturi plates;
volume and pressure of air being drawn between the venturi plates;
temperature of the air flowing between the venturi plates; and,
diameter and construction of the cyclone collector.

By appropriate manipulation of these parameters, glass flakes can be produced which are flat or wavy, of substantial variance in thickness or consistence of thickness, and which are large or small in cross-section.

Particular parameters, the control of which has allowed glass flake of very low thickness, are the control of the glass stream from the melt tank at higher temperatures, the ability to regulate the mass stream accurately, the ability to control the spinning of the molten film accurately and to stretch that film before it is super-cooled and broken into flake.

In particular, the production of a glass stream at a higher temperature than previously used with less mass flow and less heat loss from the stream is important. Furthermore, insulation of the spinning cup as opposed to cooling, and closer tolerances on the cup size and annular venturi, a higher velocity through the venturi and lower air pressure, are all important.

Particular values of ranges of parameters which have been found to be useful in the production of very thin glass flake are as follows:
mass flow between 0.4 and 2.5 kilos per minute;
glass temperature at control nozzle of from 1050 to 1500° C.;
glass temperature at spinning cup from 1000 to 1380° C.;
distance between melt tank control nozzle and entry to spinning cup of from 75 to 850 nm;
spinning cup diameter of from 20 to 100 mm OD;
spinning cup depth of from 15 to 80 mm;
spinning cup externally cooled, insulated or heated;
distance between edge of spinner and entry to annular venturi of from 10 to 275 mm;
the gap between plates forming the annular venturi of from 2 to 22 nm; and,
air pressure within the system of from 120 to 760 mm water gauge.

Glass flake of around nano-thickness can be obtained from Glassflake Limited.

In the production of the glass flakes, they may be coated with an agent to improve their bonding to the rubber and in tire treads and walls using glass flake, a silane promoter may be used to significant advantage. The glass flake may be an amino silane-coated glass flake. Preferably, the glass flake is coated with bis(3-triethoxy silylpropyl) disulphane (Silquest A-1589). More preferably, the glass flake is coated with 4,4,13,13-tetraethoxy-3,14-dioxa-8,9-dithia-4,13-disilahexadecane (Degussa S1266). A combination of silanes or other adhesion promoters may also be used to advantage.

While only several embodiments of the present invention have been shown and described, it will be obvious to those skilled in the art that many modifications may be made to the present invention without departing from the spirit and scope thereof.

What is claimed is:

1. A vehicle tire, comprising:
a filler including glass flake.

2. The vehicle tire according to claim 1, wherein said filler is present in a tread of said vehicle tire.

3. The vehicle tire according to claim 1, wherein said filler is present in a sidewall of said vehicle tire.

4. The vehicle tire according to claim 1, wherein said glass flake of said filler has a thickness of up to 1000 nm.

5. The vehicle tire according to claim 1, wherein said glass flake has an average particle size that is greater than 80 nm.

6. The vehicle tire according to claim 1, wherein said glass flake has a planar dimension of D50 that is from 5 μm to 250 μm.

7. The vehicle tire according to claim 1, wherein said glass flake has an average particle size thickness of from 100 to 400 nm and a D50 planar dimension that is from 20 μm to 50 μm.

8. A vehicle tire according to claim 1, wherein said glass flake is coated with a bonding agent.

9. The vehicle tire according to claim 8, wherein said bonding agent is a silane.

10. The vehicle tire according to claim 9, wherein said silane is an amino silane.
